(19) United States
(12) Patent Application Publication
(10) Pub. No.: US 2011/0196720 A1
(43) Pub. Date: Aug. 11, 2011

(54) METHOD FOR EFFECTING GOOD HAND HYGIENE PRACTICES

(76) Inventors: Sharon M. Guten, Beachwood, OH (US); Patricia A. Taylor, New Philadelphia, OH (US); Sonia A. Alemagno, Russell, OH (US)

(21) Appl. No.: 12/701,890

(22) Filed: Feb. 8, 2010

(51) Int. Cl. G06Q 10/00; G06F 15/16; G06Q 50/00; G06Q 99/00

(52) U.S. Cl. 705/7.42; 709/206

(57) ABSTRACT

An online system and method for improving individual hand hygiene practices includes a central program manager including a processing unit, server, and memory necessary for interactive internet communication with a host of users. Each user or participant may access the software program when, where and however she/he desires, provided internet access is available. The online learning system and method maintained by the program manager is divided into three sessions, each comprising a module, each module being tailored to educate the participant about hand hygiene practices and to elicit from the participant a self-assessment of any shortcomings that the participant may perceive himself/herself as having in the area of hand hygiene. The participant may then develop a hand hygiene self-improvement plan, focusing on a number of such deficiencies, which will be the focus of attention of the participant in a real world setting with dispensing apparatuses until the participant selects the time and place to work on next module. During the interim period of time, the program manager, through internet communication, sends email and pop-ups to the participant to further encourage, educate, and make the participant aware of the hand hygiene practices of particular interest. Several progressive stages or modules of this type are employed, each evoking from the participant a commitment to change, and each intercommunication being of a personalized nature, and directed specifically to the needs evidenced by the self-improvement plan of the participant.

### TECHNICAL FIELD

The invention herein resides in the art of behavioral management and, more particularly, to the establishment and maintenance of particular behaviors on both a personal and an institutional-wide basis. Specifically, the invention relates to the establishment and maintenance of good hand hygiene practices in institutional environments, by facilitating individuals' improvement in such practices. More, specifically, the invention provides an apparatus and technique allowing individuals to conveniently and privately engage a self-improvement hand hygiene program.

### BACKGROUND ART

Good hand hygiene practices are a requisite for good health. While personal hand hygiene practices may directly impact the health of an individual, the corporate or institutional practices of individuals associated therewith may greatly impact the health of multitudes of others through transmission of communicable disease. It is well known that disease and infection is often transferred from one person to another as a consequence of poor hand hygiene practices by one or more persons in a chain of transmission. In the hospitality industry, where employees have contact with food, service ware, bedding and the public, the possibilities for transmitting germs from one person to another are great. Schools, day care centers and offices have similar issues. But, the issue is probably most pronounced in the healthcare industry itself.

Studies document that healthcare-associated infections cause approximately 90,000 deaths per year and nearly one third of these, or 30,000 deaths, are attributable to poor hand hygiene. Indeed, the Centers for Disease Control recognizes that improved hand hygiene compliance with standards for infection control practice is a key to substantially reducing healthcare-associated infections.

The failure of workers to employ good hand hygiene practices results from a confluence of factors including lack of knowledge of standards, apathy, time pressures, resistance to change, and perceived inconvenient location of hand disinfection dispensing apparatuses for hand washing and hand sanitization. Indeed, there are many excuses for the failure to comply with hand hygiene standards in many key industries and, while the healthcare industry will be primarily addressed herein, it will be understood that the problems and resultant solutions presented are applicable to a a range of industries and service organizations.

While the need for good hand hygiene has been well known and documented in the past, it is also well-documented that good hand hygiene behavior—like many health behaviors—is difficult to consistently undertake and maintain. Past efforts in addressing the problem have typically been disappointing, at best, with little attention or effort directed to effecting the behavior and cultural changes necessary to bring about lasting change in an institutional environment. Indeed, as presented herein, only by effectively addressing the issue of hand hygiene on an individual level may results be consistently achieved on an institutional basis. The basic building block of any institution is the individual employee and in the case of the healthcare industry, it is the healthcare worker, whether a physician, nurse, aide or therapist. Only by effecting individual behavioral change among these building blocks may change be realized in the institution as a whole.

While education about good hand hygiene practices is a necessary condition for healthcare workers compliance with hand hygiene standards, education alone is not sufficient to produce consistent hand hygiene compliance. Like other hard-to-change behaviors (e.g., exercise, healthy eating, and safe driving), hand hygiene compliance behavior requires relinquishing unhealthy habits and acquiring new behaviors. Indeed, there is a need for a behavior management technology that gives tools to both the hospital manager responsible for hand hygiene compliance of healthcare workers and tools for continuing learning and improvement for individual healthcare workers. The invention presented and described herein provides that technology.

Specifically, the instant invention recognizes the need for individuals' private self-assessment and development of their hand hygiene practices as a condition for maintaining a culture of patient safety and quality through such practices in institutions. The invention recognizes the need not only for individualized private learning, but accommodates the schedules of the healthcare workers such that the method may be engaged at those times most convenient for the healthcare worker, when not distracted by other pressing patient care needs. Moreover, a self-paced interactive method for hand hygiene self-assessment, learning, and practice improvement training aims to effect behavior change, and the present invention seeks to integrate interactive learning with actual performance of good hand hygiene in the workplace as healthcare workers learn when and how to engage with hand disinfection dispensing apparatuses as a consequence of their learning.

### DISCLOSURE OF INVENTION

In light of the foregoing, it is a first aspect of the invention to provide a method for effecting individuals' good hand hygiene practices to achieve a culture of patient safety at the institutional level.

Another aspect of the invention is the provision of an online method for effecting individuals' good hand hygiene practices to achieve behavioral change at the individual level.

It is yet another aspect of the invention to provide an online method for effecting individuals' good hand hygiene practices that accommodates the private learning for the individual through individualized self-assessment, knowledge acquisition, and implementation of an individual hand hygiene improvement plan.

Still a further aspect of the invention is the provision of an online method for effecting individuals' good hand hygiene practices that is structured for self-assessment and remedial action, as required.

An additional aspect of the invention is the provision of an online method for effecting individuals' good hand hygiene practices that is accessible at any time or place to accommodate the schedules of the users of such method.

Yet a further aspect of the invention is the provision of an online method for effecting individuals' good hand hygiene practices that features interactive learning techniques so suitable for adult learners.

Still another aspect of the invention is the provision of an online method for effecting individuals' good hand hygiene practices that is structured in stages to allow the user to gradually and systematically acquire and implement knowledge regarding good hand hygiene practices.

A further aspect of the invention is the provision of an online method for effecting individuals' good hand hygiene practices that allows for managers to gather and assess statistics regarding workers' knowledge and implementation of good hand hygiene practices in a particular work site area of interest and subsequent provision of feedback to the work unit regarding its aggregate performance.

The foregoing and other aspects of the invention that will become apparent as the detailed description proceeds are achieved by an online method for improving individual hand hygiene practices within an institution, comprising: individually interconnecting a participant's internet communication device with a program manager, said program manager having a processing unit and software for interactive communication with the participant; uniquely logging said participant into said interactive communication; sequentially engaging in a plurality of sessions of self-assessment by said participant of hand hygiene practices and development of hand hygiene self-improvement plans based thereon, said sessions being controlled by said program manager; and effecting communications between said program manager and said participant between said sessions to implement said hand hygiene self improvement plans.

### DESCRIPTION OF DRAWINGS

For a complete understanding of the structure and method of the invention, reference should be made to the following detailed description and accompanying drawings wherein:

FIG. 1 is a block diagram of the online system of the invention; and

FIG. 2, is a detailed flow diagram of the online method of the invention in one implementation thereof.

### BEST MODE FOR CARRYING OUT THE INVENTION

The invention herein contemplates an online system and methodology by which individual healthcare practitioners or others, depending upon the involved industry, may interface through the worldwide web (“internet”) with a program manager and proceed at their own time, location and pace in an interactive manner to assess their own knowledge with regard to hand hygiene, self-assess and quantify their own strengths and weaknesses in that area, and participate in a structured methodology that serves to improve individual hand hygiene practices. The concept of the invention is to provide time for the healthcare worker to acquire and reflect upon knowledge and gradually add new hand hygiene behaviors to the infection control practice repertoire of the healthcare practitioner. The method of the invention requires simply a laptop computer or other similar device adaptable for interconnection with the internet for communication with a program manager on an interactive basis. The method of the invention preferably comprises a three module structure that requires the participant to “live with” his/her learnings in order to increase mindfulness of such person's own hand hygiene behaviors. The invention is predicated upon the fact that complex behavior change does not occur overnight. Hence, the three module online method of the invention paces the participant to gradually acquire knowledge about hand hygiene practices, to gain awareness of his/her own limitations, to state intention to improve in self-selected targeted areas, and to apply the learnings to acquisition and performance of particular hand hygiene behaviors.

It will be appreciated that the method of the invention increases the mindfulness of the healthcare practitioner about particular hand hygiene practices at the onset of the program through the use of a pretest regarding hand hygiene practices, a brief presentation regarding such practices, and a post presentation quiz—all three of which bring to the attention of the practioner important salient facts regarding hand hygiene. Immediately following this, with a hand hygiene self-assessment, participants rate themselves on performance with respect to a number of very specific hand hygiene behaviors. This self-assessment personalizes the learnings just achieved, and raises awareness of one's own hand hygiene behaviors, and does so with particularity—not just in general terms. Since it is generally known that healthcare workers are conscientious, and since the method of the invention is undertaken in private, there is no inducement for the participants to inflate their self-assessment in order to “look good” to either themselves or their mangers, particularly since managers are not provided with access to individual results. Accordingly, the method of the invention precludes any inclination or desirability to distort reports of an individual's own hand hygiene practices. In fact, studies have shown that participants in the inventive method do not give themselves overstated assessments, demonstrating that self-assessment enables the participants to focus on particular and various hand hygiene practices to achieve a better understanding of options for improvement.

Although undertaken in private, the apparatus and process of the online method presented herein gives the participants feedback about hand hygiene practice information and knowledge through such mechanisms as hand hygiene knowledge pretest, post test, computer-delivered teaching of standards of when and how to interact with hand disinfection apparatuses, and self-assessment of good hand hygiene practices that utilize hand disinfection apparatuses for handwashing and hand sanitization following the requisite standards. The methodology provides multiple opportunities for feedback because timely information about performance has been found to be important for behavior change, particularly with adult learners.

A key to the success of the online method herein is the opportunity for the participants to set their own hand hygiene practice goals and to successfully execute those good hand hygiene practices in hospital patient care settings, by interacting with a variety of hand disinfection apparatuses for handwashing and hand sanitization. In the structured methodology of the invention, in a first phase the participant chooses up to three specific hand hygiene practices to work on during a set period of time until the next phase is entered. In the second phase, the participant has a second opportunity to choose additional hand hygiene practices to be improved prior to a third phase. A benefit of this methodology of the invention results from the fact that the psychology of learning demonstrates that adult learners respond well when given the opportunity to choose their own goals, instead of having a manager direct them to improve areas of the manager's choice. In conjunction with this choice, the process of the online method of the invention asks the participant to form and state intentions to improve her/his chosen hand hygiene practices at the various stages. This process is based upon research that demonstrates that when people state an intention to change behavior, there is an increased probability that subsequent behavior change will occur.

A key to the success of the methodology of the invention is the fact that the online method presented herein allows participants to learn in optimal circumstances of their own choice—typically when the individual is best suited for learning. The online method may be practiced at work, at home, on a break, in the middle of the night, when dressed for work, dressed for relaxation, or at a time when the individual desires a learning experience. Adult learners typically have many demands and priorities. Accordingly, the method herein provides a technology that enables healthcare workers to focus on hand hygiene competencies at any time and in any place where access to the internet is available.

As will further be appreciated herein, the online method of the invention provides for customized email tips to the user that are provided between the various learning phases or modules of the invention. These prompts are personalized to the individual's choices made for self improvement in the first two phases or modules. In accordance with the invention, customized prompts are employed because it has been found that targeted, tailored reminders are more effective than impersonal, non-specific ones. Typically, adult learners prefer personally relevant information that applies directly to them and their work.

The online method is both a behavioral management technology for the hospital manager responsible for hand hygiene compliance of healthcare workers and a learning and engagement tool for healthcare workers. Further, the online method presented herein may optionally include unit metrics allowing a hospital manager, such an infection control practitioner, health educator, or epidemiologist to obtain statistics about a particular work unit's aggregate hand hygiene knowledge, knowledge gained, and self-assessed hand hygiene compliance behavior. Such data can be used by the manger to reinforce good hand hygiene practices among healthcare workers within such a unit.

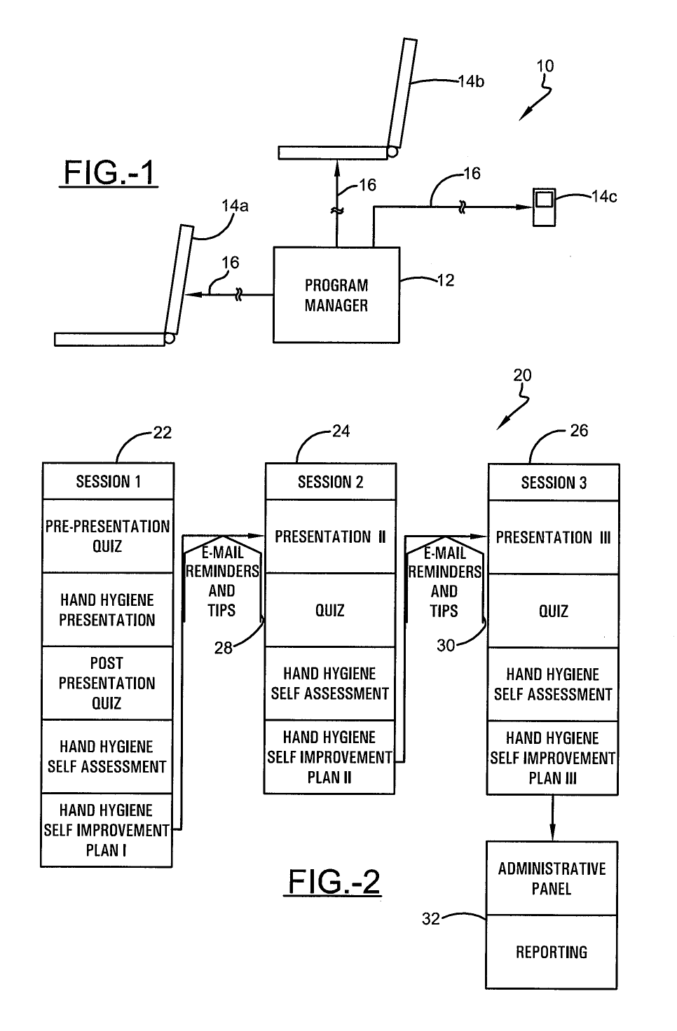

Referring now to the drawings and more particularly FIG. 1, it can be seen that the physical system of the invention is designated generally by the numeral 10. At the heart of the system 10 is a program manager 12, consisting of hardware of an appropriate central processing unit, memory, and servers to run the software of the interactive methodology presented below with regard to FIG. 2. The program manager 12 selectively communicates on demand with various remote locations 14a, 14b, 14c, through connection to the internet 16. The remote locations 14a-c may comprise any appropriate unit or technology capable of internet communication, including laptop computers, pda's, cellular phone systems, and the like. Accordingly, access can be made to the program manager 12 at virtually any time and from any place having internet access.

The software of the invention provides, in the first instance, for a login methodology for each of the users/participants. Various information regarding such individual can be obtained, including name, address, work position, years of experience, licensure, education level, employer, and the like. While this information is gathered by the program, it is kept confidential and, to the extent that data is shared with an institution or the like, it is only statistical data as to a particular group or groupings of participants.

Each time a user accesses the program of the program manager 12, he/she does so by use of a secure login methodology, well known and understood to those skilled in the art. Upon access, the user is taken to the point in the program where he/she last participated or, alternatively, the participant may select to redo a portion of the program, as desired. FIG. 2 illustrates the program and the three preferred phases or modules thereof, the program being designated generally by the numeral 20. The three phases or modules of learning correlate with three sessions 22, 24, 26 to be sequentially engaged by the participant over a course of time as he/she moves through the methodology of the invention. The methodology of the invention will be discussed below in the normal sequence of operations, it being understood that at any point in time, a participant may desire to revert back to an earlier session either for refreshing or reinforcing.

With particular reference to FIG. 2, it can be seen that session 1 of the first module 22 may begin with a pre-educational presentation quiz, which is preferably a short quiz with true/false or multiple choice questions to assess the baseline knowledge of the participant with regard to hand hygiene practices. This quiz is configured to take approximately 5-15 minutes, and more preferably approximately 10 minutes, to keep the attention of the user. This pre-presentation test serves to focus an awareness of the participant on hand hygiene practices to be discussed immediately thereafter. Following the pre-educational presentation test, a hand hygiene educational presentation, in the form of either a recorded live video or a slide show is played for the participants. The hand hygiene presentation highlights the standards and importance of good hand hygiene practices in the healthcare arena, or other particular area of interest, and addresses the various topics of hand hygiene knowledge that were the covered in the pre-educational presentation test. The presentation seeks to dispel myths and commonly-held misunderstandings with regard to the standards and methodology of good hand hygiene practices to minimize the risk of disease transfer within a healthcare facility or other area of interest. The presentation includes statistical data addressing such areas as the number of deaths resulting from bad hand hygiene practices, the need for sanitizing one's hands despite the use of gloves, the importance of peer influence to remind others to practice good hand hygiene by sanitizing or washing.

In session 1 of the module 22, following the hand hygiene presentation, the participant takes a post-presentation quiz, allowing the participant to reinforce for him/herself the knowledge just gained from the hand hygiene presentation.

Following this quiz, in the privacy of the site selected by the participant, the participant takes a hand hygiene self-assessment, consisting of 10-15 questions as to how often the participant engages in specified hand hygiene practices, allowing the participant to select between “sometimes,” “usually,” “mostly,” “almost always,” and “always.” These available selections have increasing weighted values associated therewith, such that a self-assessment score may be attained at the end of the self-assessment practice. The results of the self-assessment are posted on the screen of the laptop, pda, cell phone or the like employed by the participant, who may then assess his/her strengths and weaknesses in the area of hand hygiene practices.

The final stage of the first module 22 is to establish a hand hygiene self-improvement plan by selecting from the self-assessment results a number of areas upon which to focus for improvement over a coming course of time. It has been found that a selection of three such areas of improvement is sufficient to ensure good results. The number is not so overwhelming as to frustrate the participant, and is not so small as to allow the participant to lose sight of the fact that good hand hygiene practice is a constellation of a number of discrete practices. The selected areas of focus might include (1) remind others to wash or sanitize their hands, (2) wash and sanitize hands both before and after eating and (3) wash or sanitize your hands before donning gloves.

Upon establishment of a hand hygiene self-improvement plan, the participant leaves session 1 of module 22 and over the course of a set period of time, such as 2-4 weeks, focuses upon improving her/his practices in the three selected areas for the self-improvement plan. During this period of time, reminders and tips relevant to the selected goals are issued to the participant through email messages and “pop-ups” periodically throughout the day. These reminders and tips are directed specifically to the areas of self-improvement designated by the participant and may be tailored to the specific participant by name. Accordingly, the participant is focused and directed particularly to the three areas of interest to the participant with guidelines, tips and reminders tailored to those specific areas of interest and to the specific participant, ensuring a maximum probability of success.

After the participant has spent 2-4 weeks working on her/his hand hygiene self-improvement plan developed in session 1 at module 22, then he/she begins session 2 of module 24 by again accessing the program of the program manager 12 through an appropriate device 14 over the internet 16. Here, a second presentation may be given, reinforcing the need for and methodologies of good hand hygiene practices in the area of interest. Following that presentation, a quiz may be given and a score published. Next, a hand hygiene self-assessment period is entertained, substantially similar to that of session 1. The results are displayed for viewing by the participant such that a second hand hygiene self-improvement plan may be developed. Here again, the participant chooses improvement areas from among a number of areas of hand hygiene practice. Typically, three such areas are chosen. These areas may include or overlap with certain of those selected for the first hand hygiene self-improvement plan in session 1 of module 22. They may, however, include different areas such as (1) wash or sanitize your hands before direct patient contact, like positioning a patient in a bed, checking a pulse, taking blood pressure, etc., (2) wash or sanitize your hands after removing gloves, and (3) wash or sanitize your hands after touching items used in nursing care areas, such a phones, computers and the charts. Again, the self-assessment and generation of the second hand hygiene self-improvement plan occurs in the privacy of the participant's internet communication device. During the next set period of time, such as 2-4 weeks, the participant receives at 30 email reminders and tips or pop-ups on his/her internet communication device tailored specifically to the participant's behavioral areas selected for the second hand hygiene self-improvement plan. Over this course of time, the participant focuses upon a number of hand hygiene practices of particular concern selected for the second hand hygiene self-improvement plan. Such practices typically involve the timely and effective utilization of dispensers of liquid sanitizers, soaps or the like. These dispensers are typically located to encourage and facilitate their use, and may be in various forms such as wall mount, counter mount, point of care, personal bottle and the like.

At the end of engagement of the second hand hygiene self-improvement plan, session 3 of module 26 is engaged. Here again, a presentation may be made with regard to hand hygiene standards and practices. A quiz may also be undertaken, with the score being displayed as feedback to the participant about his/her knowledge acquisition. A hand hygiene self-assessment, such as those in sessions 1 and 2 may also be engaged. Finally, the participant may commit to a hand hygiene self-improvement plan in this final session of the program, with this self-improvement plan typically being a long-term improvement plan to ensure, to the greatest extent possible, maintenance of the good hand hygiene practices acquired during the first two sessions of modules 22, 24.

It will be appreciated that in a preferred embodiment of the invention the self-assessment step typically is directed to only 12 areas of hand hygiene practice. With each of the first two sessions allowing for the selection of three of those areas for improvement, at the end of the program, up to half of the areas of interest may have been selected for improvement. This is generally found to be sufficient for most healthcare workers. What is required then is simply a long-term improvement or maintenance plan which may contemplate reversion back to an implementation of the entire program 20 on a periodic basis, such as every 6 months or the like.

As mention earlier, the invention features the option of provision of data to a personnel manager through an administrative panel that records and displays aggregate data from various hand hygiene knowledge quizzes, hand hygiene self-assessments and improvement plans as at 32. It will be appreciated that only raw data is provided, without any information regarding particular participants, their score, knowledge, self-assessments, or plans as attributed directly to them. This raw data may be used for assessing and analyzing the knowledge of workers in a particular unit and their improvement in hand hygiene practices over a course of time, on a unit and not a personal basis. This information may allow the personnel manager to develop focused remedial programs to address any specific learning problems or anomalies identified in the raw data.

Thus it can be seen that the various aspects of the invention have been satisfied by the structure and method presented and described above. A methodology for self-improvement in hand hygiene practices has been presented that allows the participants to engage the method while maintaining integrity and privacy, thus ensuring optimum honest and forthright participation, in achieving not only individual improvement, but institutional improvement as well.

In accordance with the patent statutes, only the best mode and preferred embodiment of the invention has been presented and described in detail, but the invention is not limited thereto or thereby. Accordingly, for an appreciation of the true scope and breadth of the invention reference should be made to the following claims.

What is claimed is:

1. An online method for improving individual hand hygiene practices within an institution, comprising:
individually interconnecting a participant's internet communication device with a program manager, said program manager having a processing unit and software for interactive communication with the participant;
uniquely logging said participant into said interactive communication;
sequentially engaging in a plurality of sessions of self-assessment by said participant of hand hygiene practices and development of hand hygiene self-improvement plans based thereon, said sessions being controlled by said program manager; and
effecting communications between said program manager and said participant between said sessions to implement said hand hygiene self-improvement plans.

2. The online method for improving individual hand hygiene practices within an institution according to claim 1, wherein said communications between said sessions are tailored specifically to said participant and said participant's self-improvement plan.

3. The online method for improving individual hand hygiene practices within an institution according to claim 2, wherein said communications are in the nature of customized and timely email correspondence.

4. The online method for improving individual hand hygiene practices within an institution according to claim 3, wherein a first session comprises a first module that makes a hand hygiene educational presentation, followed by a first hand hygiene self-assessment, and then development of a first hand hygiene self-improvement plan.

5. The online method for improving individual hand hygiene practices within an institution according to claim 4, wherein said first module further comprises testing associated with said educational presentation, said testing measuring and reinforcing knowledge of hand hygiene practices with said participant.

6. The online method for improving individual hand hygiene practices within an institution according to claim 5, wherein said first module further comprises a pre-presentation quiz as an initial step to focus the attention of the participant on hand hygiene practices to be addressed later.

7. The online method for improving individual hand hygiene practices within an institution according to claim 4, wherein said second session comprises a second module temporally spaced from said first session by a first period of time during which said participant practices said first hand hygiene self-improvement plan by practicing proper use of sanitizer dispensers and receives said communications.

8. The online method for improving individual hand hygiene practices within an institution according to claim 7, wherein said second module comprises a second hand hygiene self-assessment and development of a second hand hygiene self-improvement plan.

9. The online method for improving individual hand hygiene practices within an institution according to claim 8, wherein a third session comprises a third module temporally spaced from said second session by a second period of time during which said participant practices said second hand hygiene self-improvement plan by practicing proper use of sanitizer dispensers and receives said communications.

10. The online method for improving individual hand hygiene practices within an institution according to claim 9, wherein said first and second hand hygiene self-assessment serves to identify hand hygiene practice areas of concern, those practice areas of concern being addressed by said first and second hygiene self-improvement plans.

11. The online method for improving individual hand hygiene practices within an institution, according to claim 10, wherein said practice areas of concern are selected from a same group of potential practice areas of concern for each of said first and second self-improvement plans.

12. The online method for improving individual hand hygiene practices within an institution according to claim 11, wherein said temporal spacings are between two and four weeks.

13. The online method for improving individual hand hygiene practices within an institution according to claim 12, wherein each said self-improvement plan comprises three opportunities practice areas of concern.

14. The online method for improving individual hand hygiene practices within an institution according to claim 11, wherein said third module comprises a third hand hygiene self-assessment by said participant, and the development of a long-term self-improvement plan directed to a range of hand hygiene practices.

15. The online method for improving individual hand hygiene practices within an institution according to claim 14, further comprising a fourth module that affords a personnel manager to receive data, not attributed to any individuals, pertaining to said first, second and third self-assessments and assessing the hand hygiene practice needs of an entire work unit therefrom.

16. The online method for improving individual hand hygiene practices within an institution according to claim 15, further comprising the step affording the personnel manager the data to tailor a targeted hand hygiene program for said work unit based on data from aggregated assessments of the hand hygiene practice needs thereof.

17. The online method for improving individual hand hygiene practices within an institution according to claim 11, wherein said participants select when, where, and how to participate in said sessions.

18. The online method for improving individual hand hygiene practices within an institution according to claim 17, wherein development of a said self-improvement plan elicits a statement of intention to change by said participant.
